(19) United States
(12) Patent Application Publication
(10) Pub. No.: US 2022/0350641 A1
(43) Pub. Date: Nov. 3, 2022

(54) SECURELY CASCADING PIPELINES TO VARIOUS PLATFORMS BASED ON TARGETING INPUT

(71) Applicant: Microsoft Technology Licensing, LLC, Redmond, WA (US)

(72) Inventors: Paul David GILMORE, Kirkland, WA (US); Todd Joseph BELLO, Kenmore, WA (US); Debojyoti HALDAR, Redmond, WA (US); Arun-Gangadhar Gudur RAO, Lynnwood, WA (US)

(73) Assignee: Microsoft Technology Licensing, LLC, Redmond, WA (US)

(21) Appl. No.: 17/242,859

(22) Filed: Apr. 28, 2021

(51) Int. Cl. G06F 9/48; G06F 21/30; G06F 9/451; G06F 11/36; H04L 29/06; G06F 8/41

(52) U.S. Cl. CPC G06F 9/4843; G06F 21/30; G06F 9/451; G06F 11/3692; H04L 63/102; G06F 8/41

(57) ABSTRACT

Examples of the present disclosure describe systems and methods for securely cascading build pipelines to various software engines, hardware platforms, and/or devices. In aspects, a set of input parameters may be received by a software automation and/or development system. Based on the set of input parameters, the system may create a software build job to test software for various build pipelines. Upon execution of the software build job, the system may identify a set of software engine-specific or hardware platform-specific software build devices. The system may cause the set of software build devices to concurrently build respective software. One or more test programs of the software may be executed, and the corresponding test results may be provided to a results location. The system may securely access the test results in the result location(s) and present the test results for the software build job in a single user interface.

### BACKGROUND

The software development process relies on various build system tools and utilities to build and test software products. In many cases, a build system is limited to creating software products for a specific hardware platform or hardware device. Due to this limitation, developing software products for multiple hardware platforms or hardware devices generally requires incorporating multiple build systems or implementing multiple configurations for one or more build systems. In both scenarios, the build process is fragmented into several disparate build jobs that must be separately configured, executed, monitored, and resolved. Such a build process is cumbersome, resource-intensive, and becomes increasingly impractical as the number and variety of software products to be tested increases.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for securely cascading build pipelines to various platforms and/or devices. In aspects, a set of input parameters is received by a software automation and/or development system. Based on the set of input parameters, the system creates a software build job to test software for various computing environments, hardware platforms, hardware devices, and/or software versions. Upon execution of the software build job, the system identifies a set of software build devices or agents, each of which may be configured to create one or more software development kits (SDKs) for a particular computing environment or hardware platform. The system causes the set of software build devices or agents to concurrently build respective SDKs. The set of software build devices or agents may deploy the SDKs to a deployment location or to a set of endpoint devices, thus completing the pipeline (e.g., the route from the system to the deployment location or endpoint device). One or more test programs of the deployed SDKs may be executed, and the test results of the test programs may be provided to one or more results location. The system securely accesses the test results in the result location(s). The system then presents the test results for the software build job in a single user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for securely cascading build pipelines to various platforms and/or devices.

FIG. 2 illustrates an example input processing system for securely cascading build pipelines to various platforms and/or devices.

FIG. 3 illustrates a diagram of an example cascading software build pipeline.

FIG. 4 illustrates an example method for method for securely cascading build pipelines to various platforms and/or devices.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

Continuous integration or continuous delivery (Cl/CD) environments provide systems and tools for automating the aspects of software development relating to building, testing, and deploying software. In many cases, Cl/CD environments are configured to facilitate software development for a single computing environment or configuration, such as a software engine, a software engine version, a software language, a hardware platform, or a software version. Due to this limitation of Cl/CD environments, developing software for multiple computing environments/configurations generally requires the use of multiple, disparate software build tools (e.g., build servers and build automation software) that are each specific to a particular computing environment/configuration. Build, as used herein, may refer to the process of converting files and/or other software objects into a useable software product. In examples, the build process may include compiling source files, compressing or otherwise optimizing the compiled files, generating installer objects, etc.

Typically, the disparate software build tools for respective computing environments/configurations are not compatible. As a result, each of these software build tools may generate one or more software build jobs, build tasks, or build activities (collectively referred to herein as “software build jobs” or “build job”) for building, testing, and deploying software. The software build jobs may define one or more pipelines (e.g., pathway) in which data flows from a source computing device or environment to an endpoint computing device or environment. For example, a first pipeline may define a path between a first software build machine/agent (configured to operate with a first software engine) and a first set of devices, while a second pipeline may define a path between a second software build machine/agent (configured to operate with a second software engine) and a second set of devices. In examples, a pipeline may include one or more intermediate devices or environments. Each software build job and/or pipeline may be separately configured, executed, monitored, and resolved by a corresponding software build tool. Consequently, a user executing the various software build tool is required to manually execute multiple software build job, collect multiple sets of test results for each pipeline in the software build job, aggregate and normalize the sets of test results, and evaluate the test results for each software build job and pipeline. This fragmented, manual build process is cumbersome and resource-intensive, requires users to have knowledge of multiple build technologies and processes, and becomes increasingly impractical as the number and variety of pipelines increases.

To address the challenges with conventional build systems and processes, the present disclosure describes systems and methods for securely cascading build pipelines to various platforms and/or devices. In aspects, a set of input parameters is received by an orchestration system for facilitating software automation and/or development. The set of input parameters may define multiple pipelines encompassing multiple computing environments/configurations. Based on the set of input parameters, the orchestration system creates a single software build job to test and/or deploy software for each of the pipelines. The software build job represents a single cascading pipeline for the multiple computing environments/configurations defined by the set of input parameters. The software build job may comprise the input parameters and other necessary information for synchronously (and/or asynchronously) testing and/or deploying software for each of the pipelines. For example, a user may execute the software build job by selecting a single button or control provided by the orchestration system.

Once the software build job has been executed by the orchestration system, one or more software build devices or agents accessible to the orchestration system is identified based on the set of input parameters. For example, a first build agent that is configured to operate with a first hardware platform identified by the set of input parameters is identified and a second build agent that is configured to operate with a second hardware platform identified by the set of input parameters is identified. The software build job may cause each of the identified build devices or agents to concurrently build SDKs for the computing environments/configurations associated with the respective build devices or agents. The build devices or agents may deploy the SDKs to a deployment location, such as an SDK repository, or to a set of endpoint devices, such as mobile phones, gaming devices, etc. After (and/or prior to) deploying the SDKs, one or more test programs may be executed against the deployed SDKs. In examples, the test program(s) verify that an SDK compiles, is syntactically correct, or otherwise performs as intended.

The test results for the test program(s) are provided to one or more secure results locations. An indication that the test results are available at the secure results locations may be provided to, or identified by, the orchestration system. The orchestration system may collect the test results from the secure results locations using a set of security credentials. The security credentials ensure that the test results are securely transmitted between the secure results locations and the orchestration system. The orchestration system then presents the test results for each pipeline of the software build job in a user interface. The user interface may be configured such that the test results for the various pipelines are presented in a uniform, navigable manner. Accordingly, the user interface may enable a user to efficaciously view, navigate, and evaluate the test results for each pipeline of the software build job.

Accordingly, the present disclosure provides a plurality of technical benefits including but not limited to: improving the build execution process by enabling cascading software build pipelines that encompass multiple software engines, software engine versions, software languages, etc.; simplifying the build execution processes by enabling the execution of cascading software build pipelines from a single interface and/or button press; enabling concurrent build process execution on a plurality of disparate build devices/agents in various computing environment; securely transmitting software build requests, software, and software test results using a security credential selected during build job creation; increasing the processing speed of software build requests by allocating additional processing services (e.g., build agents) in real-time; decreasing resource waste associated with software build requests by deallocating additional processing services in real-time; and improving the complex software build process for platforms for live game development and operation, among other examples.

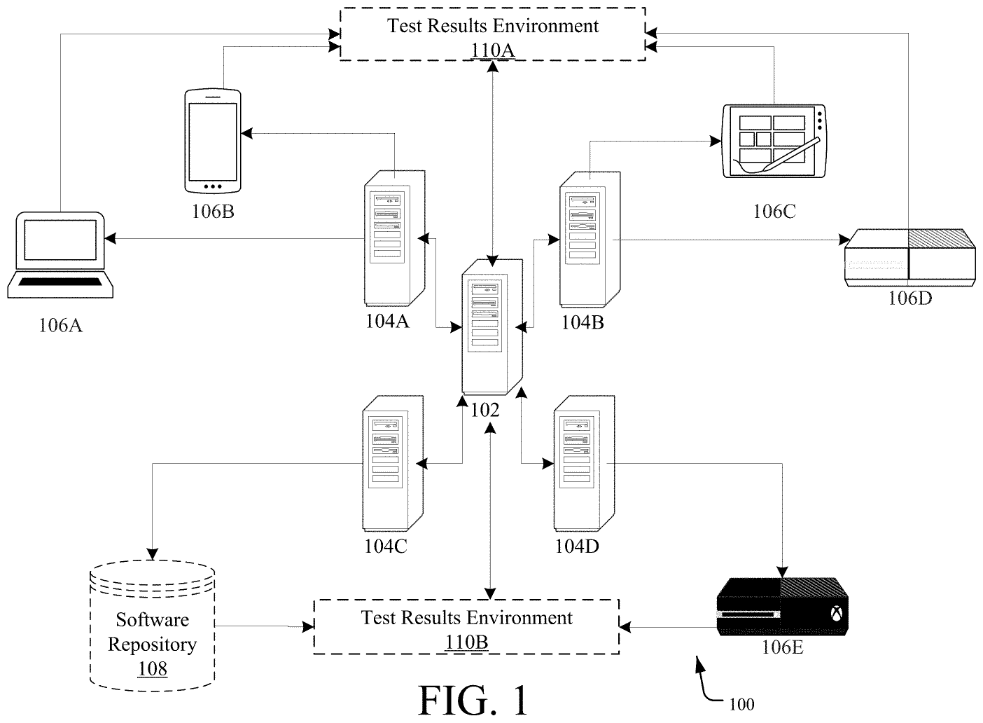

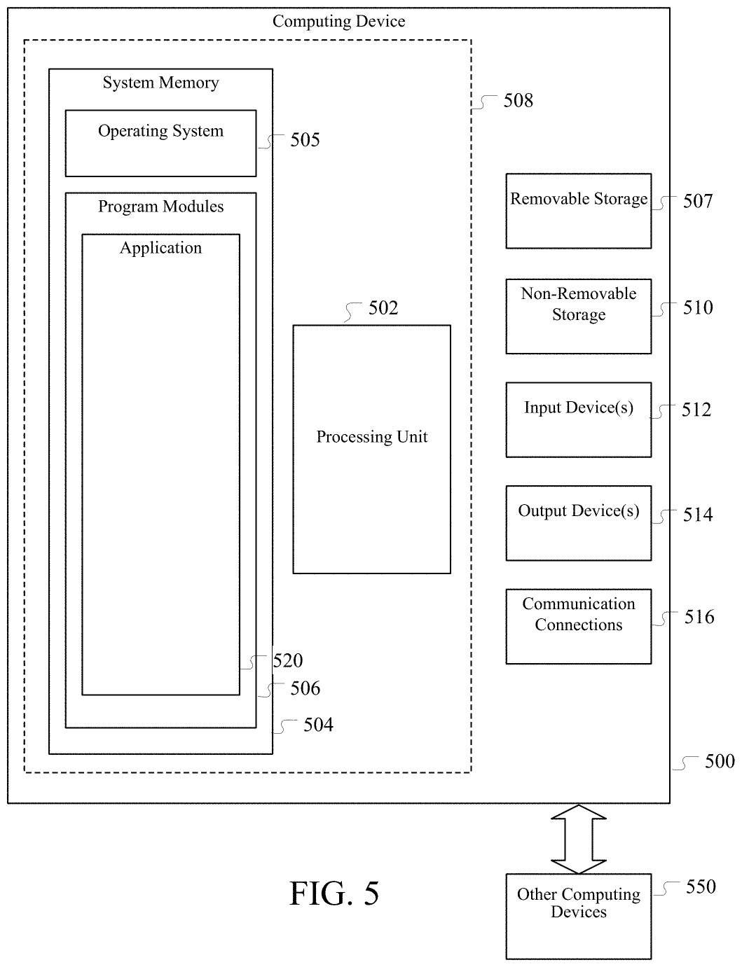

FIG. 1 illustrates an overview of an example system for securely cascading build pipelines to various platforms and/or devices. Example system 100 as presented is a combination of interdependent components that interact to form an integrated whole. Components of the system may be hardware components or software components (e.g., applications, application programming interfaces (APIs), modules, virtual machines, or runtime libraries) implemented on and/or executed by hardware components of the system. In one example, system 100 may provide an operating environment for software components to execute and utilize resources or facilities of system 100. An example of one or more processing devices comprising such an operating environment is depicted in FIGS. 5-8. In another example, the components of systems disclosed herein may be distributed across multiple devices. For instance, input may be entered on a user or client device and information may be processed on or accessed from other devices in a network, such as one or more remote cloud or web server devices.

In FIG. 1, system 100 comprises orchestration device 102, build device 104A, 104B, 104C, and 104D (collectively “build device(s) 104”), endpoint devices 106A, 106B, 106C, 106D, and 106E (collectively “endpoint device(s) 106”), software repository 108, and test result environments 110A and 110B (collectively “test result environment(s) 110”). One of skill in the art will appreciate that the scale of systems such as system 100 may vary and may include additional or fewer components than those described in FIG. 1. As one example, additional build device(s) 104 are logically or geographically positioned between orchestration device 102 and build device(s) 104 or between build device(s) 104 and endpoint device(s) 106. In such an example, the additional build device(s) 104 are configured to perform testing on a subset (or a superset) of the of computing environments/configurations available to an upstream (or a downstream) build device(s) 104. As another example, orchestration device 102 may be directly connected to one or more of endpoint device(s) 106. As yet another example, build device(s) 104 may be directly connected to test result environment(s) 110.

Orchestration device 102 is configured to facilitate software automation and/or development. For example, orchestration device 102 may be implemented as a Cl/CD environment that enables building, testing, and deploying software across various computing environments/configurations. Such computing environments/configurations encompass, for example, build device or agent signatures, software engines, hardware platforms, software languages, and software versions. A build device or agent signature, as used herein, refers to an API specification or definition that explains the behavior/functionality, expected result, organization, and/or link structure of an API.

In aspects, orchestration device 102 may be implemented in any of several computing environments, such as a cloud computing environment, a distributed computing environment, a client-server computing environment, a cluster computing environment, a personal computing environment, etc. Examples of orchestration device 102 include, but are not limited to, a PC, a server device, a cloud computing device, a virtual device, or the like. Although orchestration device 102 is depicted in FIG. 1 as a single device, it is contemplated that orchestration device 102 may represent multiple devices or services, and that the components and/or functionality of orchestration device 102 may be distributed among multiple devices. For instance, orchestration device 102 may represent a cluster of cloud devices that each comprise or have access to one or more software automation and/or development services.

Orchestration device 102 provides an interface (or alternate input receiving modality) that enables a user to select or create one or more build jobs. The interface enables a user to select a set of input parameters defining one or more build pipelines. The build pipelines may correspond to multiple combinations of computing environments/configurations. For example, a first pipeline (or set of pipelines) may be defined for a first hardware platform, a second pipeline (or set of pipelines) may be defined for a second hardware platform, and so forth. The interface further enables a user to execute a single build job comprising each of the pipelines defined by the set of input parameters. Accordingly, the single build job represents a cascading pipeline.

In aspects, the single build job generates or otherwise comprises the commands and information to concurrently execute the build process for each of the pipelines. The single build job may also generate or otherwise comprise the commands and information for identifying and communicating with the build devices/agents that are defined by each pipeline. For instance, orchestration device 102 may generate a list of build devices that are configured to perform the software build process for the computing environments/configurations identified in the set of input parameters. To generate the list of build devices, orchestration device 102 identifies the capabilities of one or more build devices by querying the build devices directly, querying a service or information source comprising information about the capabilities of the build devices, or using any other means.

Build device(s) 104 are configured to build, test, and/or deploy software for a specific computing environment/configuration. For example, each build device(s) 104 may build SDKs and/or other software products for a particular software engine, hardware platform, or software version. Building the SDKs and/or other software products comprises merging the source code bases of one or more users (e.g., developers) to a main source code repository (e.g., trunk) that is accessible by multiple users. The merging includes executing and passing unit tests for the user's source code in a user's local environment, compiling the user's source code, executing and passing integration tests for the compiled source code, and/or merging the compiled source code to the main source code repository.

Build device(s) 104 may be implemented in any of several computing environments discussed with respect to orchestration device 102. Examples of build device(s) 104 include at least those devices discussed with respect to orchestration device 102. For instance, each of build device(s) 104 may be a server device that implements one or more build agents (e.g., a computing infrastructure that comprises job execution software and executes the build process). Alternately, one or more of build device(s) 104 may be implemented as a virtualized solution, such as a virtual machine. The virtualized solution(s) may be allocated or deallocated in real-time, as needed. For instance, one or more virtual machines are allocated based on build job request volume, the number of pipelines encompassed by a build job, or the amount of computational processing power required by the build system.

In aspects, build device(s) 104 receive a build instruction from orchestration device 102. The build instruction indicates the computing environment/configuration for which the build process is to be executed by build device(s) 104. The build instruction is or includes a set of commands for initiating the build process, a request to initiate the build process, a connection request, authorization/authentication information, or the like. Based on the build instruction, build device(s) 104 initiates a build process. The build process causes one or more software products to be at least built and tested by build device(s) 104. For example, a first build device(s) 104 builds and test software for a first software engine and a second build device(s) 104 builds and test software for a second software engine. The software may comprise one or more test programs for testing the software. In some aspects, build device(s) 104 executes one or more of the test programs of the software. The test programs generate one or more test results. Build device(s) 104 transmit the test results for the software to one or more test result locations, such as test result environment(s) 110.

Build device(s) 104 are configured to deploy built and tested software to one or more deployment locations. For example, build device(s) 104 deploy software to one or more devices, such as endpoint device(s) 106. As another example, build device(s) 104 deploy software to one or more software repositories and/or software management services, such as software repository 108. The deployment locations may be identified by the received build instruction. Alternately, the deployment locations may be identified based on a predefined list of locations/devices, user settings information, and/or preexisting connection data of build device(s) 104. For instance, build device(s) 104 may be physically or virtually connected to one or more deployment locations. Build device(s) 104 deploy software to all or a subsection of the connected locations/devices.

Endpoint device(s) 106 are configured to receive and execute deployed software. For instance, endpoint device(s) 106 receive software from build device(s) 104. One or more test programs of the received (deployed) software are executed by endpoint device(s) 106. The test programs generate one or more test results for the software. Endpoint device(s) 106 are further configured to transmit the test results for the software to one or more test result locations, such as test result environment(s) 110. Examples of endpoint device(s) 106 include, but are not limited to, personal computers (PCs), gaming consoles or devices, mobile devices (e.g., smartphones, mobile gaming units, tablets, laptops, personal digital assistants (PDAs)), and wearable devices (e.g., smart watches, smart eyewear, fitness trackers, smart clothing, body-mounted devices, virtual reality (VR)/augment reality/mixed reality headsets and devices). In aspects, each endpoint device(s) 106 correspond to a specific computing environment/configuration. For example, a first endpoint device(s) 106 and a second endpoint device(s) 106 may be configured for use with a particular first software engine and hardware platform. The first endpoint device(s) 106 receives software for a first software version for the hardware platform and the second endpoint device(s) 106 receives software for a second software version for the hardware platform.

Software repository 108 is configured to store and manage software. For example, software repository 108 includes one or more software package management components that enable users (e.g., developers) to share reusable software code. Alternately, software repository 108 simply stores software, software documentation, and/or software location information. Although software repository 108 is depicted herein as a single object, it is contemplated that software repository 108 may represent multiple devices and/or services.

Test result environment(s) 110 are configured to store software test results. For example, test result environment(s) 110 receives software test results from build device(s) 104 and/or endpoint device(s) 106. Test result environment(s) 110 stores the software test results in one or more locations or data stores. The software test results may be stored securely using one or more security mechanisms. For example, the stored software test results may only be accessible using a security object (e.g., token, certificate, key, password/passphrase, authentication credential). In at least one aspect, test result environment(s) 110 transmit an indication that the rest results have been received to orchestration device 102 and/or build device(s) 104. In response to the transmitted indication, orchestration device 102 and/or build device(s) 104 use the security object to access/collect the software test results from test result environment(s) 110. In some aspects, test result environment(s) 110 correspond to a platform that provides user access to one or more services, applications, utilities, and/or analytics tools. As a specific example, test result environment(s) 110 may correspond to backend platform for building and operating live games, accessing managed game services and real-time analytics, and/or storing software packages.

Orchestration device 102 is further configured to present software test results. For example, orchestration device 102 uses the interface described above (or an alternate user interface) to present the software test results for a build job comprising pipelines for various computing environments/configurations. The interface may present the software test results for each pipeline of the build job in a consistent or standardized format. For example, the interface presents each of the software test results using a common theme, style, row/column format, set of data labels, etc. In some aspects, the software test results for each pipeline are presented on a single display screen, webpage, or website such that a user may efficaciously view, navigate, and evaluate the software test results for the build job.

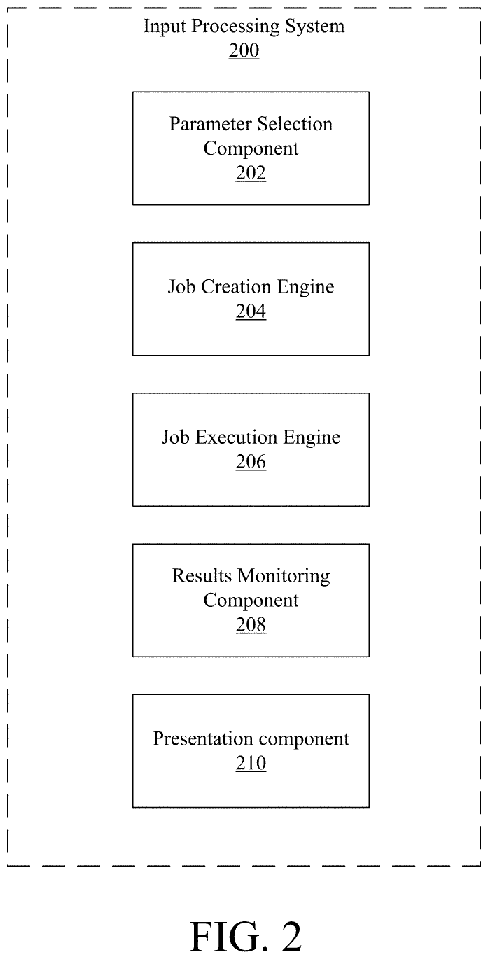

FIG. 2 illustrates an example input processing system for securely cascading build pipelines to various platforms and/or devices. The techniques implemented by input processing system 200 may comprise the techniques and data described in system 100 of FIG. 1. Although examples in FIG. 2 and subsequent figures will be discussed in the context of software build automation, the examples are equally applicable to other contexts, such workflow automation. In some examples, one or more data and components described in FIG. 2 (or the functionality thereof) are distributed across multiple devices. In other examples, a single device comprises the data and components described in FIG. 2.

Input processing system 200 represents a software automation and/or development solution. The solution enables a user to concurrently build, test, and deploy software across multiple computing environments/configurations in response to the execution of a single build job. The solution also enables the user to view, navigate, and evaluate the software test results for the build job. In FIG. 2, input processing unit 200 comprises parameter selection component 202, job creation engine 204, job execution engine 206, results monitoring component 208, and presentation component 210. One of skill in the art will appreciate that the scale of input processing system 200 may vary and may include additional or fewer components than those described in FIG. 2.

Parameter selection component 202 is configured to enable a user to select from one or more input parameters. The input parameters may be presented via an interface provided by parameter selection component 202 or input processing system 200. For example, parameter selection component 202 provides a graphical user interface (GUI) that is accessible to one or more users having access to input processing system 200. The GUI provides access to a list of selectable or configurable input parameters. The input parameters correspond to, for example, software build options relating to one or more software build pipelines. Examples of input parameters include, but are not limited to, software engine (e.g., game engine, physics engine, graphics engine, workflow engine, inference engine), hardware platform, hardware platform version, build machine/agent signature, security parameters (e.g., credentials object, security object, authentication object), software repository parameters (e.g., commit message, destination branch, input branch), compression parameters (e.g., compression package type, whether to use compression, compression flags/variables), SDK restrictions (e.g., public or private methods), test execution options (e.g., enabling/disabling particular test/debugging programs and utilities), build job frequency (e.g., one-time, hourly, nightly), and publishing/deployment parameters (e.g., publishing/deployment location(s), whether to publish/deploy, publishing/deployment authorization information).

Job creation engine 204 is configured to create one or more software build jobs. In aspects, job creation engine 204 has access to input parameters received by parameter selection component 202. Job creation engine 204 may use parsing and/or pattern matching techniques to identify the computing environments/configurations identified in or implicated by the received input parameters. For each computing environment/configuration identified, job creation engine 204 determines one or more build pipelines. For example, received input parameters comprise build information for a first software engine, a version of the software engine, a first hardware platform associated with the first software engine, a second software engine, a version of the second software engine, and a second hardware platform associated with the second software engine.

Based on the received input parameters, job creation engine 204 creates and/or identifies a first build pipeline (e.g., based on the first software engine, the version of the first software engine, and the first hardware platform) and a second build pipeline (e.g., based on the second software engine, the version of the second software engine, and the second hardware platform). Creating and/or identifying the build pipelines may comprise querying one or more build devices/agents to identify which of the build devices/agents are configured to build/test software for each build pipeline. For example, job creation engine 204 queries the build devices/agents using software engine identifiers, hardware platform identifiers, and/or other information associated with the received input parameters. In response to the query, each build devices/agents respond with information, such as a confirmation/denial of being configured/available to perform the build process for the queried parameters (e.g., software engine identifiers, hardware platform identifiers), a list of capabilities of the build device/agent, access information for the build device/agent (e.g., IP address, authorization credential, authentication information), test result information (e.g., test result location, required security credential for accessing test results), etc.

After creating and/or identifying the build pipelines identified/implicated by the received input parameters, job creation engine 204 automatically creates a single build job that comprises/encompasses the build pipelines. For example, each build pipeline is created as a task (or a sub-task) of the build job. In some aspects, the build job comprises or is accompanied by commands and information required to concurrently execute (or initiate the execution of) the build process for each of the build pipelines. The build job may also comprise a security credential (or an indication thereof) to be used by the build devices/agents to securely perform the build process. The security credential is identified using the received input parameters.

Job execution engine 206 is configured to execute a build job. In aspects, the build job created by job creation engine 204 is provided to job execution engine 206. Job execution engine 206 may establish a communication session with each build device/agent indicated by the build job. Job execution engine 206 then transmits a build instruction and/or a security credential to each build device. The build instructions received by each build device may comprise information, formatting, and/or syntax that is specific to the receiving build device. For instance, a first build instruction is configured for a first computing language or environment and a second build instruction is configured for a second computing language or environment. The build instruction indicates the computing environment/configuration for which the build process is to be executed. The build instruction also comprises a set of commands for initiating the build process on the individual build devices/agents, a request to initiate the build process on the individual build devices/agents, a connection request, authorization/authentication information, or the like. In some examples, the build instruction comprises the security credential (or a reference thereto).

Results monitoring component 208 is configured to monitor the results of the build job. For example, the build devices/agents build, test, and/or deploy one or more software products as part of the build job. Result data of the build process for the software products is published or otherwise made accessible to one or more result storage locations or devices. The result data may include, but is not limited to, executed test programs (e.g., test program names or identifiers), test program results (e.g., passed, failed, skipped), result explanations (e.g., reason test program failed or was skipped), result notes, and result metrics (e.g., number of tests executed, passed, failed, skipped). The result data may be stored securely using one or security mechanisms. For example, the result data is encrypted or otherwise secured such that a security object, such as the security credential, is needed to access the result data.

Results monitoring component 208 monitors the result storage locations or devices to determine when result data is published. For example, results monitoring component 208 polls (e.g., sample the status of) the result storage locations or devices for result data at predefined time intervals (e.g., every ‘X’ seconds, minutes, or hours). Alternately, results monitoring component 208 receives an indication when result data is available. For example, the result storage locations or devices (or a service/device associated therewith) transmits an indication (e.g., a notification, an alert, an email message) to input processing system 200. Results monitoring component 208 detects or receives the indication and may cause the result data to be collected by input processing system 200.

In at least one aspect, the result data is collected from the result storage locations or devices using the security credential. For example, results monitoring component 208 uses a security credential associated with the build job to access the result storage locations or devices. The stored result data is transmitted from the result storage locations or devices to input processing system 200. In some examples, the result data is encrypted or otherwise secured during (or prior to) transmission. When the result data is received by input processing system 200, the result data is decrypted using the security credential or an alternative security object.

Presentation component 210 is configured to present the result data or provide the result data for display. For example, presentation component 210 presents the result data via the interface provided by parameter selection component 202. Alternatively, a different user interface may be used. The interface organizes the result data such that the result data for each pipeline of the build job is presented in a consistent or standardized format (e.g., using a common theme, style, row/column format, or set of data labels). For example, result data for a first pipeline of the build job comprises a first set of data labels and values (e.g., “test 1—passed,” “test 2—failed,” “test 3—skipped”) and result data for a second pipeline of the build job comprises a second set of data labels and value (e.g., “passed test program A,” “failed test program B,” “could not execute test program C”). Presentation component 210 may standardize the first and second set of data labels and values to create a common format (e.g., “test 1:pass,” “test 2:fail,” “test 3:skip”). Presentation component 210 is further configured to present the result data using an interface that enables the result data for each pipeline to be presented on a single display screen, webpage, or website. Accordingly, presentation component 210 enables viewing, navigating, and evaluating the result data for the build job in a single interface or location.

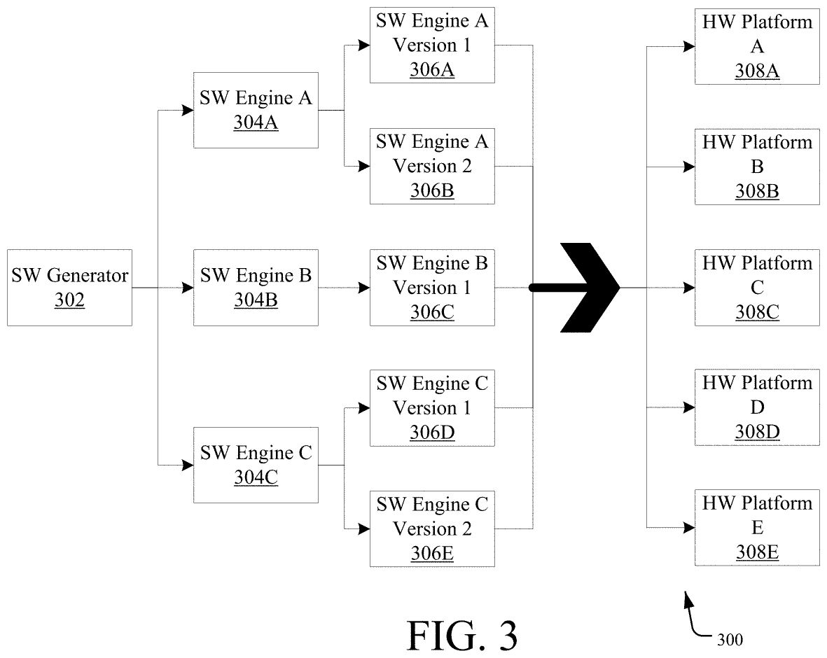

FIG. 3 illustrates a diagram of an example cascading software build pipeline (“cascading pipeline”) that is generated using the for secure cascading build pipelines techniques described herein. Example cascading pipeline 300, as presented, comprises software generator 202, software engines 204A-C, software engine versions 206A-E, and hardware platforms 208A-E. One of skill in the art will appreciate that the scale of cascading pipeline 300 may vary and may include additional or fewer components than those described in FIG. 3. For example, cascading pipeline 300 may further include hardware platform versions, geographic locations, device identifier ranges, or the like.

In FIG. 3, software generator 302 is a build instruction, build functionality, or a build component, such as build device(s) 104, job creation engine 204, or job execution engine 206. Software generator 302 represents the first (initial) node of each build pipeline. Software engines 304A-C may each represent a software engine type (e.g., game engine, physics engine, graphics engine), a software engine programming language (e.g., C++, C#, Lua, Java), a software engine development platform (e.g., Unity engine, Unreal engine, Godot engine), or the like. Software engines 304A-C represent the second node of each build pipeline. Software engine versions 306A-E may each represent a software engine version, software engine project code name, software engine year, etc. Software engine versions 306A-E represent the third node of each build pipeline. Hardware platforms 308A-E may each represent a hardware platform type (e.g., Xbox, Windows, macOS, Linux, PlayStation, Nintendo: Switch, AppCenter: Android, AppCenter iOS), software platform type (e.g., technology platform, computing platform, utility platform), operating system, programming language, etc. Hardware platforms 308A-E represent the fourth node of each build pipeline.

Having described various systems that may be employed by the aspects disclosed herein, this disclosure will now describe one or more methods that may be performed by various aspects of the disclosure. In aspects, method 400 is executed by a system, such as system 100 of FIG. 1 or input processing system 200. However, method 400 is not limited to such examples. In other aspects, method 400 is performed by a single device or component that integrates the functionality of the components of system 100 or input processing system 200. In at least one aspect, method 400 is performed by one or more components of a distributed network, such as a web service/distributed network service (e.g. cloud service).

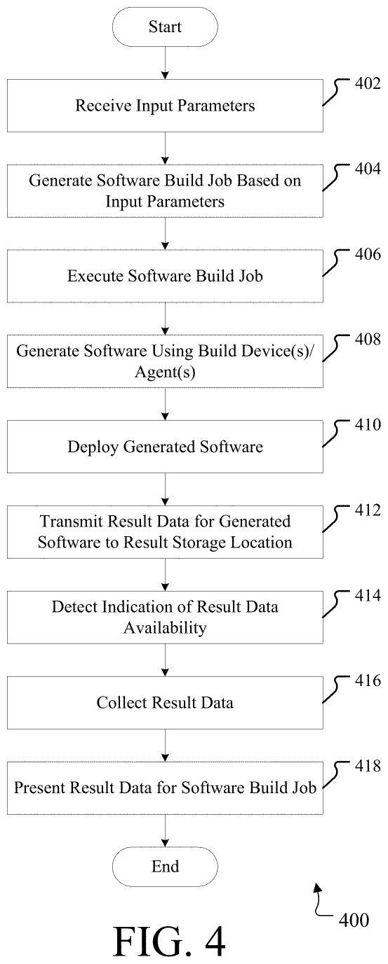

FIG. 4 illustrates an example method for securely cascading build pipelines to various platforms and/or devices. Example method 400 begins at operation 402, where one or more input parameters are received. In aspects, a selection of input parameters is received by a software build orchestration component, such as orchestration device 102. The input parameters correspond to software build options that define one or more build pipelines that collectively encompass multiple computing environments/configurations (e.g., software engines, software engine versions, software languages, hardware platforms, software versions). For example, received input parameters may define at least a first build pipeline incorporating a first software engine, a second build pipeline incorporating a second software engine, a third build pipeline incorporating a third software engine, and security credentials.

At operation 404, a software build job is generated. In aspects, the received input parameters are used to build a software build job. For example, a job creation mechanism, such as job creation engine 204, uses the received input parameters to create a single software build job. The software build job is configured to test and/or deploy software for each of the pipelines identified by the input parameters. In some examples, the software build job comprises the information necessary to concurrently build, test, and/or deploy software on multiple build devices/agents. For instance, the software build job comprises input parameter data and build execution instructions for concurrently causing a first build device to execute a first build pipeline, a second build device to execute a second build pipeline, and a third build device to execute a third build pipeline. The software build job also comprises the information necessary to identify build devices/agents to be used by the software build job. For example, the software build orchestration component uses the received input parameters to generate a list of build devices that are configured to perform the software build process for each identified pipeline. The list of build devices comprises device/agent identifiers, authorization/authentication information, device/agent capability information, utilization metrics, network topology information, etc.

At operation 406, a software build job is executed. In aspects, the software build orchestration component executes the software build job in response to a real-time user request, in accordance with a predefined schedule, or based on the fulfillment of a one or more conditions. As one example, a user manually executes the software build job by selecting a button on or issuing a command to the software build orchestration component. Upon execution of the software build job, software build orchestration component establishes a communication session (or otherwise indicate a request to communicate) with one or more build devices/agents. Each of the build devices/agents may be transmitted build request information (e.g., build instructions, build execution commands, security credentials, authorization/authentication information, results monitoring information). For example, the software build orchestration component sends each build device/agent a build script, a credentials file associated with the software build job (or with the respective build device/agent), and a location to store the software build job results. The build request information is configured to be generic or build device/agent-agnostic (e.g., common to or usable by multiple devices/agents), or the build request information may be customized or build device/agent-specific. For instance, the build request information for two different build devices/agents may be in separate programming languages and/or may comprise different types and formats of information.

At operation 408, one or more build devices/agents generate software for the software build job. In aspects, the identified build devices/agents receive the build request information from the software build orchestration component. Based on the build request information, the identified build devices/agents initiate a build process to build and test software for the software build job. A security credential provided by the software build orchestration component may be included in, or used to construct, the generated software. For example, a first build device/agent generates software for a first software engine and a set of hardware platforms, and a second build device/agent may generate software for a second software engine and the set of hardware platforms. A security credential is embedded in the software generated by each build device/agent. In aspects, the build process is initiated (or at least a portion of the build process may be executed) synchronously on each build device/agent. Alternatively, the build process is initiated and/or executed asynchronously on one or more build devices/agents. In at least one aspect, the software generated by a build device/agent is tested by the build device/agent to verify that the software compiles and/or is syntactically valid.

At operation 410, the generated software is deployed. In aspects, the software generated by the build devices/agents is deployed to one or more deployment locations. For example, the generated software is deployed to a software repository and/or to one or more endpoint devices. After the generated software has been deployed, one or more test programs in the generated software are executed by the endpoint device or deployment location. The test programs may be configured to determine whether the generated software performs as intended or expected. Executing the test programs generates result data that include, for example, executed test programs names or identifiers, test program results, result explanations, result notes, and/or result metrics.

At operation 412, the result data is transmitted to a result storage location. In aspects, the endpoint device or deployment location transmits the result data to one or more result storage locations. The endpoint device or deployment location may also transmit a security credential to the result storage location. The security credential is used to encrypt or otherwise secure the result data from unauthorized users. For example, the security credential identifies a compression package and an encryption algorithm to apply to the test results. The security credential may also identify or comprise a security object that is required to access and/or download the test results.

At operation 414, an indication of result data availability is detected. In aspects, the software build orchestration component receives an indication that the result data has been transmitted to the result storage location(s). The indication may be a notification, an alert, a message, or the like. In some examples, the indication is generated and/or transmitted by the result storage location, an endpoint device or deployment location, or a build device/agent. For example, upon receiving the result data and/or security credential, the result storage location transmits event data (e.g., result data availability) to an event listener mechanism of the software build orchestration component. In other examples, the software build orchestration component polls the result storage location(s) for the result data at predefined time intervals (e.g., every ‘X’ seconds, minutes, or hours).

At operation 416, the result data is collected. In aspects, upon identifying that the result data is available, the software build orchestration component collects the result data from the result storage location(s). To collect the result data, the software build orchestration component may provide the security credential (or an alternative security object) to the result storage location(s). When the security credential is provided, the result storage location(s) attempts to validate the security credential. If the security credential is not validated, the result storage location(s) prevents access to the result data. If the security credential is validated, the result storage location(s) enables transmission of the result data to the software build orchestration component. The result data may be encrypted or otherwise obfuscated prior to or during transmission. Accordingly, the software and result data for the various build pipelines is securely transmitted to/from the various components engaged during the software build job.

At operation 418, the result data is presented. In aspects, the software build orchestration component causes the result data to be available for presentation. For example, the software build orchestration component presents the result data for each pipeline of the software build job in one or more user interfaces. The user interface(s) organize the result data such that the result data for each pipeline of the software build job is presented in a consistent or standardized format. Accordingly, the user interface enables viewing, navigating, and evaluating the result data for the software build job in a single interface or location.

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices and systems described above. In a basic configuration, the computing device 500 includes at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 includes an operating system 505 and one or more program modules 506 suitable for running software application 520, such as one or more components supported by the systems described herein. The operating system 505, for example, is suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) performs processes including, but not limited to, the aspects, as described herein. Other program modules that are used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 are integrated onto a single integrated circuit. Such an SOC device includes one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 includes one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein includes computer storage media. Computer storage media includes volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media includes RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media is embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

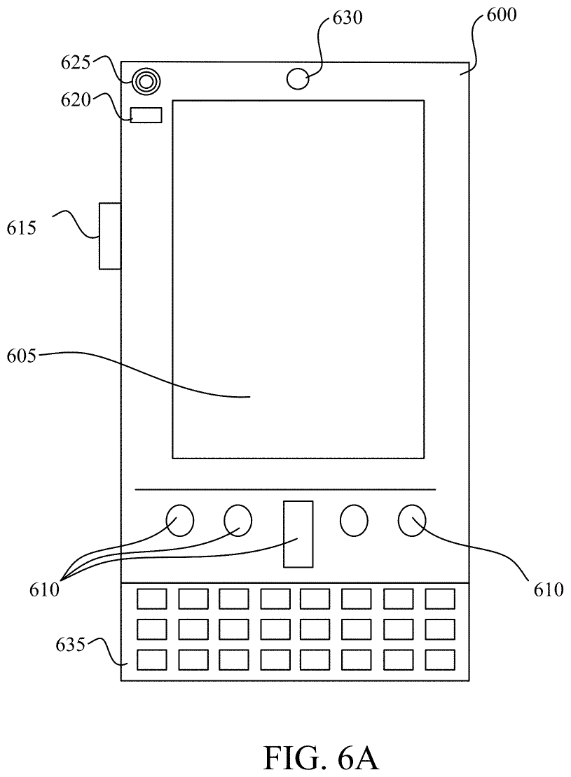

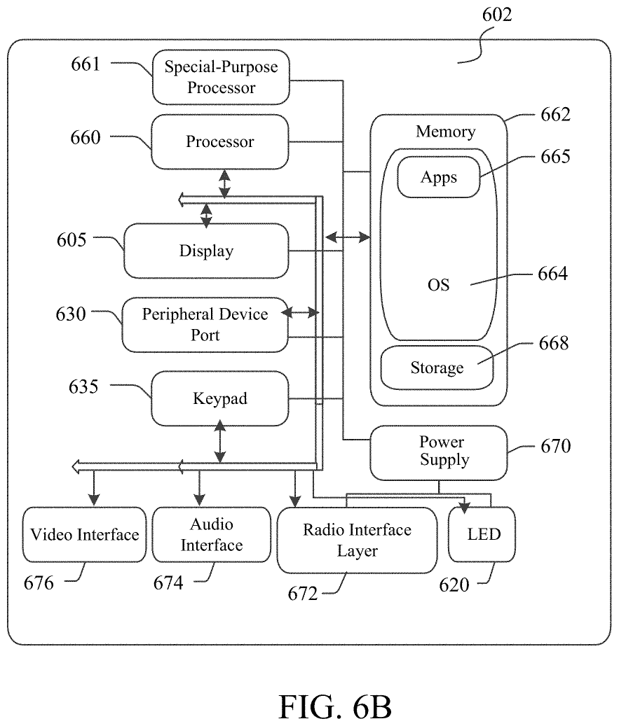

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client is a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 also functions as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 also includes an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 665 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 is used to store persistent information that should not be lost if the system 602 is powered down. The application programs 665 uses and stores information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module).

The system 602 has a power supply 670, which may be implemented as one or more batteries. The power supply 670 might further include an external power source, such as an AC adapter or a powered docking cradle that supplements or recharges the batteries.

The system 602 also includes a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 are disseminated to the application programs 665 via the operating system 664, and vice versa.

The visual indicator 620 is used to provide visual notifications, and/or an audio interface 674 is used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor(s) (e.g., processor 660 and/or special-purpose processor 661) and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 is also coupled to a microphone to receive audible input, such as to facilitate a telephone conversation. In accordance with embodiments of the present disclosure, the microphone may also serve as an audio sensor to facilitate control of notifications, as will be described below. The system 602 further includes a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 is stored locally on the mobile computing device 600, as described above, or the data is stored on any number of storage media that is accessed by the device via the radio interface layer 672 or via a wired connection between the mobile computing device 600 and a separate computing device associated with the mobile computing device 600, for example, a server computer in a distributed computing network, such as the Internet. As should be appreciated such data/information is accessed via the mobile computing device 600 via the radio interface layer 672 or via a distributed computing network. Similarly, such data/information is readily transferred between computing devices for storage and use according to well-known data/information transfer and storage means, including electronic mail and collaborative data/information sharing systems.

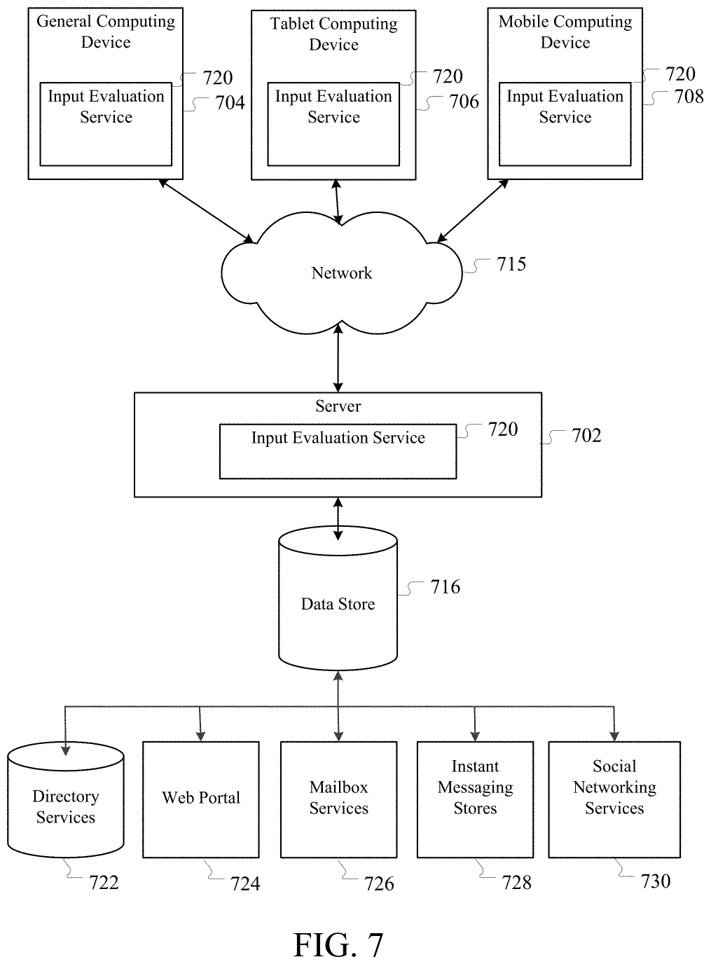

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents are stored using a directory service 722, a web portal 724, a mailbox service 726, an instant messaging store 728, or a social networking site 730.

An input evaluation service 720 is employed by a client that communicates with server device 702, and/or input evaluation service 720 is employed by server device 702. The server device 702 provides data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices obtain content from the store 716, in addition to receiving graphical data useable to be either pre-processed at a graphic-originating system, or post-processed at a receiving computing system.

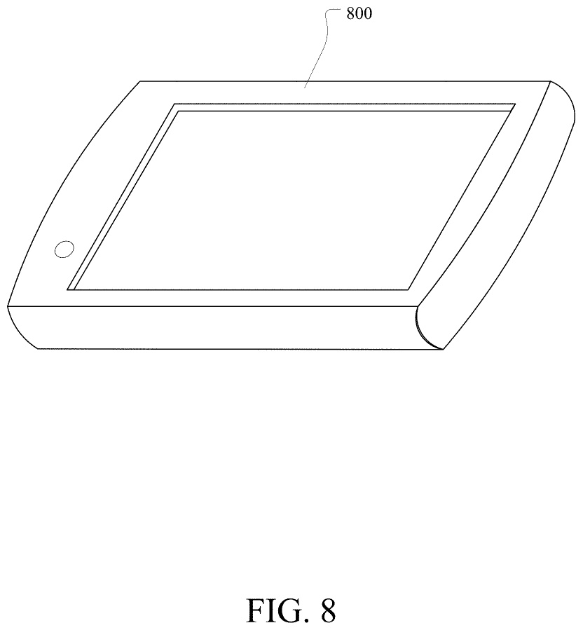

FIG. 8 illustrates an exemplary tablet computing device 800 that executes one or more aspects disclosed herein. In addition, the aspects and functionalities described herein may operate over distributed systems (e.g., cloud-based computing systems), where application functionality, memory, data storage and retrieval and various processing functions are operated remotely from each other over a distributed computing network, such as the Internet or an intranet. User interfaces and information of various types may be displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which embodiments of the invention are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system 100 comprising: a processor 660; and memory 662 coupled to the processor 660, the memory 662 comprising computer executable instructions that, when executed by the processor 660, performs a method 400. The method 400 comprising: receiving 402 one or more input parameters corresponding to a set of software build options, wherein the one or more input parameters define at least a first build pipeline and a second build pipeline; generating 404 a software build job based on the one or more input parameters, wherein the software build job is associated with a security credential and encompasses the first build pipeline and the second build pipeline; executing 406 the software build job, wherein the executing causes execution of the first build pipeline by a first build agent 104A-D and execution of the second build pipeline by a second build agent 104A-D; detecting 414 an indication that result data for the software build job is available at one or more result storage locations 110A-B; collecting 416 the result data from the one or more result storage locations 110A-B using the security credential; and providing 418 the result data for presentation. In an example, the one or more input parameters identify at least one of: a software engine 304A-C; a software engine version 306A-E, a software language; or a hardware platform 308A-E. Accordingly, the one or more input parameters enable improving the build execution process by enabling cascading software build pipelines that encompass multiple software engines, software engine versions, software languages, and hardware platforms.

In another example, the set of software build options comprise at least one of: software repository parameters; software compression parameters; or test execution options. In yet another example, the first build pipeline incorporates a first software engine 304A-C and the second build pipeline incorporates a second software engine 304A-C. In such an example, the first software engine 304A-C is a first game engine and the second software engine 304A-C is a second game engine. In yet another example, the one or more input parameters are selected from a user interface associated with a software build orchestration component 102; and the software build job is executed from the user interface. Accordingly, the user interface enables simplifying the build execution processes by enabling the execution of cascading software build pipelines from a single interface and/or button press. In yet another example, the first build pipeline and the second build pipeline are tasks of the software build job; and the tasks are automatically executed when the software build job is executed. In yet another example, executing the software build job comprises concurrently executing the first build pipeline and the second build pipeline. In yet another example, executing the software build job comprises: querying a set of build agents 104A-D to determine capabilities of the set of build agents 104A-D; receiving response data from the set of build agents 104A-D, the response data comprising at least first capability information for the first build agent 104A-D and second capability information for the second build agent 104A-D; and selecting the first build agent 104A-D and the second build agent 104A-D from the set of build agents 104A-D based on the first capability information and the second capability information. Accordingly, the capability determination enables the real-time selection of one or more build agents having a desired set of capabilities. The real-time selection provides for increasing the processing speed of software build requests by allocating additional processing services (e.g., build agents) in real-time and/or decreasing resource waste associated with software build requests by deallocating additional processing services in real-time.

In still yet another example, executing the software build job comprises: transmitting build request information to the first build agent 104A-D and the second build agent 104A-D, wherein the build request information comprises the security credential and build execution commands. In yet another example, the response data further comprises at least one of: authorization/authentication information; utilization metrics; or network topology information. In yet another example, detecting the indication that the result data for the software build job is available comprises at least one of: polling the one or more result storage locations 110A-B for the result data; or receiving a notification or message from the one or more result storage locations 110A-B. Accordingly, the mechanism for detecting he indication that the result data for the software build job is available enables the timely collection of test result data. In yet another example, the result data comprises at least one of: executed test programs; test program results; or test program metrics. In yet another example, collecting the result data comprises: providing the security credential to the one or more result storage locations 110A-B; receiving validation of the security credential; and receiving access to the one or more result storage locations 110A-B based on the validation. Accordingly, the security credential enables securely transmitting software build requests, software, and software test results using a security credential selected during build job creation. In yet another example, providing the result data for presentation comprises organizing first result data for the first build pipeline and second result data for the second build pipeline in a standardized format. In yet another example, providing the result data for presentation further comprises presenting the result data in a user interface for the software build job. Accordingly, the user interface enables the test result data for the various build pipelines of the software build job to be presented in a uniform, navigable form.

In another aspect, the technology relates to a method 400. The method 400 comprising: receiving 402, by a software build automation device 102, a selection of one or more software build options, wherein the selected one or more software build options define a plurality of build pipelines; generating 404 a software build job based on the selected one or more software build options, wherein the software build job is associated with a security credential and encompasses the plurality of build pipelines; executing 406 the software build job, wherein the executing causes execution of the plurality of build pipelines by one or more build agents 104A-D; detecting 414, by the software build automation device 102, an indication that result data for the software build job is available at one or more result storage locations 110A-B; collecting 416 the result data from the one or more result storage locations 110A-B using the security credential; and providing 418 the result data for presentation. In an example, executing the software build job comprises: establishing, by the software build automation device 102, a communication session with each of the one or more build agents 104A-D, wherein the one or more build agents 104A-D are external to the software build automation device 102; transmitting a first build instruction for the first build pipeline to the one or more build agents 104A-D; transmitting a second build instruction for the second build pipeline to the one or more build agents 104A-D; and causing concurrent execution of the first build pipeline and the second build pipeline by the one or more build agents 104A-D. Accordingly, the method enables concurrent build process execution on a plurality of disparate build devices/agents in various computing environments. In yet another example, at least one of the one or more result storage locations 110A-B is a backend platform for building and operating live games. Accordingly, the method enables improving the complex software build process for platforms for live game development and operation.

In another aspect, the technology relates to a software build orchestration device 102 comprising: a processor 660; and memory 662 coupled to the processor 660, the memory 662 comprising computer executable instructions that, when executed by the processor 660, performs a method 400. The method 400 comprising: receiving 402, via a user interface, a selection of one or more software build options, wherein the selected one or more software build options define at least a first build pipeline for a first game engine and a second build pipeline for a second game engine; generating a software build job based on the selected one or more input parameters, wherein the software build job is associated with a security credential and encompasses the first build pipeline and the second build pipeline; executing the software build job, wherein the executing causes execution of the first build pipeline by a first build agent 104A-D and execution of the second build pipeline by a second build agent 104A-D; detecting an indication that result data for the software build job is available at a result storage location 110A-B that is external to the software build orchestration device 102. Accordingly, the software build orchestration device enables improving the build execution process using cascading software build pipelines that encompass multiple software engines, software engine versions, software languages, and hardware platforms.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory coupled to the processor, the memory comprising computer executable instructions that, when executed by the processor, performs a method comprising:
receiving one or more input parameters corresponding to a set of software build options, wherein the one or more input parameters define at least a first build pipeline and a second build pipeline;
generating a software build job based on the one or more input parameters, wherein the software build job is associated with a security credential and encompasses the first build pipeline and the second build pipeline;
executing the software build job, wherein the executing causes execution of the first build pipeline by a first build agent and execution of the second build pipeline by a second build agent;
detecting an indication that result data for the software build job is available at one or more result storage locations;
collecting the result data from the one or more result storage locations using the security credential; and
providing the result data for presentation.

2. The system of claim 1, wherein the one or more input parameters identify at least one of:
a software engine;
a software engine version;
a software language; or
a hardware platform.

3. The system of claim 1, wherein the set of software build options comprise at least one of:
software repository parameters;
software compression parameters; or
test execution options.

4. The system of claim 1, wherein the first build pipeline incorporates a first software engine and the second build pipeline incorporates a second software engine.

5. The system of claim 4, wherein the first software engine is a first game engine and the second software engine is a second game engine.

6. The system of claim 1, wherein:
the one or more input parameters are selected from a user interface associated with a software build orchestration component; and
the software build job is executed from the user interface.

7. The system of claim 1, wherein:
the first build pipeline and the second build pipeline are tasks of the software build job; and
the tasks are automatically executed when the software build job is executed.

8. The system of claim 1, wherein executing the software build job comprises concurrently executing the first build pipeline and the second build pipeline.

9. The system of claim 1, wherein executing the software build job comprises:
querying a set of build agents to determine capabilities of the set of build agents;
receiving response data from the set of build agents, the response data comprising at least first capability information for the first build agent and second capability information for the second build agent; and
selecting the first build agent and the second build agent from the set of build agents based on the first capability information and the second capability information.

10. The system of claim 1, wherein executing the software build job comprises:
transmitting build request information to the first build agent and the second build agent, wherein the build request information comprises the security credential and build execution commands.

11. The system of claim 1, wherein the response data further comprises at least one of:
authorization/authentication information;
utilization metrics; or
network topology information.

12. The system of claim 1, wherein detecting the indication that the result data for the software build job is available comprises at least one of:
polling the one or more result storage locations for the result data; or
receiving a notification or message from the one or more result storage locations.

13. The system of claim 1, wherein the result data comprises at least one of:
executed test programs;
test program results; or
test program metrics.

14. The system of claim 1, wherein collecting the result data comprises:
providing the security credential to the one or more result storage locations;
receiving validation of the security credential; and
receiving access to the one or more result storage locations based on the validation.

15. The system of claim 1, wherein providing the result data for presentation comprises organizing first result data for the first build pipeline and second result data for the second build pipeline in a standardized format.

16. The system of claim 15, wherein providing the result data for presentation further comprises presenting the result data in a user interface for the software build job.

17. A method comprising:
receiving, by a software build automation device, a selection of one or more software build options, wherein the selected one or more software build options define a plurality of build pipelines;
generating a software build job based on the selected one or more software build options, wherein the software build job is associated with a security credential and encompasses the plurality of build pipelines;
executing the software build job, wherein the executing causes execution of the plurality of build pipelines by one or more build agents;
detecting, by the software build automation device, an indication that result data for the software build job is available at one or more result storage locations;
collecting the result data from the one or more result storage locations using the security credential; and
providing the result data for presentation.

18. The method of claim 17, wherein executing the software build job comprises:
establishing, by the software build automation device, a communication session with each of the one or more build agents, wherein the one or more build agents are external to the software build automation device;
transmitting a first build instruction for the first build pipeline to the one or more build agents;
transmitting a second build instruction for the second build pipeline to the one or more build agents; and
causing concurrent execution of the first build pipeline and the second build pipeline by the one or more build agents.

19. The method of claim 17, wherein at least one of the one or more result storage locations is a backend platform for building and operating live games.

20. A software build orchestration device comprising:
a processor; and
memory coupled to the processor, the memory comprising computer executable instructions that, when executed by the processor, performs a method comprising:
receiving, via a user interface, a selection of one or more software build options, wherein the selected one or more software build options define at least a first build pipeline for a first game engine and a second build pipeline for a second game engine;
generating a software build job based on the selected one or more input parameters, wherein the software build job is associated with a security credential and encompasses the first build pipeline and the second build pipeline;
executing the software build job, wherein the executing causes execution of the first build pipeline by a first build agent and execution of the second build pipeline by a second build agent;
detecting an indication that result data for the software build job is available at a result storage location that is external to the software build orchestration device;
collecting the result data from the result storage location using the security credential; and
providing the result data for presentation.
